(19) United States
(12) Patent Application Publication
(10) Pub. No.: US 2026/0285427 A1
(43) Pub. Date: Sep. 24, 2026

(54) IDLER ASSEMBLY

(71) Applicant: Caterpillar Inc., Peoria, IL (US)

(72) Inventors: Martin Tagore Joseph XAVIER, Tamilnadu (IN); Santhanam NARAYANASWAMY, Tamilnadu (IN); Anvesh TIWARI, Chennai (TN) (IN)

(73) Assignee: Caterpillar Inc., Peoria, IL (US)

(21) Appl. No.: 19/083,734

(22) Filed: Mar. 19, 2025

(51) Int. Cl. B62D 55/30; B62D 55/15

(52) U.S. Cl. CPC B62D 55/30; B62D 55/15

(57) ABSTRACT

An idler assembly for an excavator, the idler assembly including: a pair of bearing blocks; and a yoke including: a pair of parallel legs, each leg including an inner surface, an outer surface, a proximal end and a distal end, and each leg being connected at the distal end to a respective bearing block; and a spring receiving hub integrally connecting the pair of parallel legs at the proximal ends thereof.

### TECHNICAL FIELD

The present disclosure relates generally to an idler assembly, and more particularly, to a yoke for an idler assembly.

### BACKGROUND

Track type machines may be commonly used in applications where traction is critical or low ground pressure is important. Current track-driven machines use an endless track and chain assembly to provide load distribution and propulsion within a track system. Examples of track type machines may be dozers, excavators, and skid-steer loaders.

Track type machines may include an undercarriage including a track roller frame, a plurality of rollers, one or more idler wheels, a driving wheel or sprocket, and a track chain. The track chain may have track shoes that are connected to links to form an endless loop which encircles the track roller frame, the idler wheel(s) and the driving wheel. Idler assemblies may be provided to vary tension in the track chain. The idler assembly may include a tensioning system that causes the idler wheel, that is in contact with the track chain, to move so as to vary tension in the track chain.

The tensioning system may include a bearing block, yoke, tension spring, and grease adjustment cylinder. The bearing block supports the idler wheel for rotation and slides between upper and lower plates of the track roller frame. Conventionally, the yoke attaches to arms of the bearing block and couples the bearing block to the tension spring. The tension spring is coupled at an opposite end to the grease adjustment cylinder and the track roller frame.

U.S. Patent Application Publication No. US2014284996, published on Sep. 25, 2014 (“the '966 publication”), describes an idler assembly for a track roller frame. The idler assembly is designed to reduce vibrations in a track type machine. The idler assembly may include a hydraulic cylinder having a piston rod extendable along a linear actuation path, an idler wheel movable along a linear tensioning path inclined relative the linear actuation path, and a coupling mechanism coupling the piston rod to the idler wheel wherein the movement of the piston rod along the linear actuation path actuates the idler wheel to move along the linear tensioning path. As shown in FIG. 1 of the '996 publication, the yoke of the idler assembly forms a direct support for rotation of the idler wheel. As such, the support will be subject to wear, thus requiring the replacement of the entirety of the yoke during the lifetime of the track type machine. Such a system may be difficult and costly to repair and replace.

The idler assembly of the present disclosure may solve one or more of the problems set forth above or other problems in the art. The scope of the current disclosure, however, is defined by the attached claims, and not by the ability to solve any specific problem.

### SUMMARY

In one aspect, an idler assembly includes: a yoke including: a pair of parallel legs, each leg including an inner surface, an outer surface, a proximal end and a distal end; and a spring receiving hub integrally connecting the proximal ends of the pair of parallel legs.

In another aspect, an idler assembly for an excavator includes: a pair of bearing blocks; and a yoke including: a pair of parallel legs, each leg including an inner surface, an outer surface, a proximal end and a distal end, and each leg being connected at the distal end to a respective bearing block; and a spring receiving hub integrally connecting the pair of parallel legs at the proximal ends thereof.

In further aspects, an idler assembly for tensioning a track of a mobile machine includes: an idler yoke including: a pair of parallel legs, each leg including an inner surface, an outer surface, a proximal end and a distal end, and each parallel leg further including a longitudinal portion and a distal platform extending outwardly from and normal the longitudinal portion and the outer surface of each leg includes a centrally located tapering rib; and a spring receiving hub integrally connecting the pair of parallel legs at their proximal ends.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a partial sectional view of a portion of an undercarriage of a track type machine, according to aspects of the disclosure.

FIG. 2 is a perspective view of a portion of an idler assembly of the undercarriage of FIG. 1.

FIG. 3 is a perspective view of a yoke of the idler assembly of FIGS. 1 and 2.

FIG. 4 is a perspective view of a bearing block of the idler assembly of FIGS. 1 and 2.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

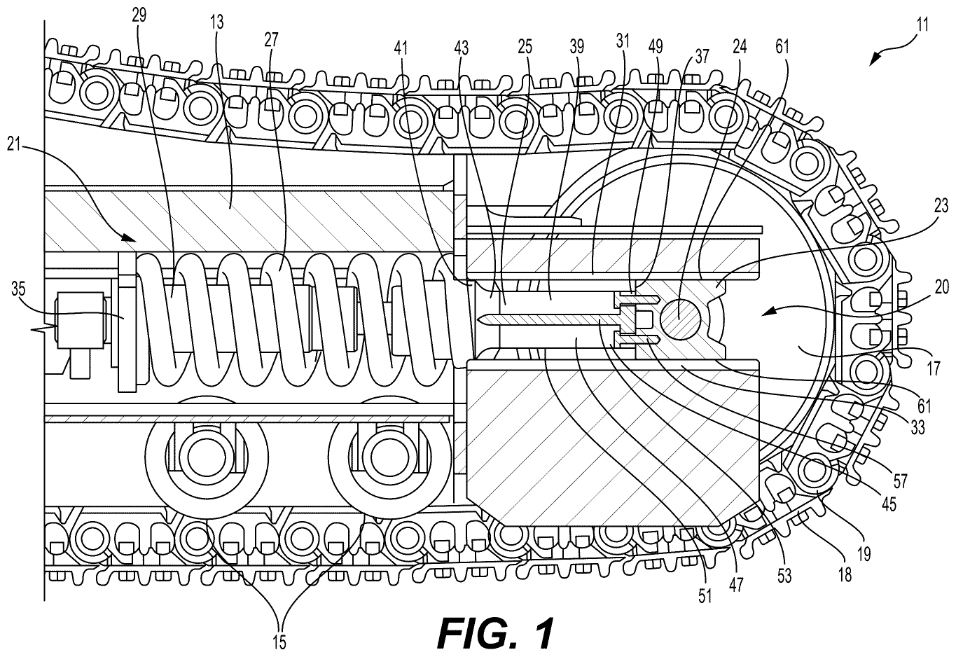

As shown in FIG. 1, track type machines may include an undercarriage 11 including a track roller frame 13, a plurality of rollers 15, one or more idler wheels 17, a driving wheel or sprocket (not shown), and a track chain 19. The track chain 19 may have track shoes 18 that are connected to links to form an endless loop which encircles the track roller frame 13, the plurality of rollers 15, the idler wheel(s) 17 and the driving wheel. Idler assembly 20 may be provided to vary tension in the track chain 19. The idler assembly 20 may include a tensioning system 21 that causes the idler wheel 17, that is in contact with the track chain 19, to move (to the left or right in FIG. 1) so as to vary tension in the track chain 19.

The tensioning system 21 may include a pair of bearing blocks 23 (one on each side of the idler wheel 17), a yoke 25, a tension spring 27, and a grease adjustment cylinder 29. Each bearing block 23 receives an axle 24 of the idler wheel 17 for supporting rotation of the idler wheel 17. The bearing blocks 23 also slide between upper and lower plates 31, 33 of the track roller frame 13. The yoke 25 attaches to a bearing block proximal end 37 of each bearing block 23, and couples the bearing blocks 23 to the tension spring 27. The tension spring 27 extends at least part of the distance between a proximal end of the yoke 25 and a proximal plate 35 of the adjustment cylinder 29.

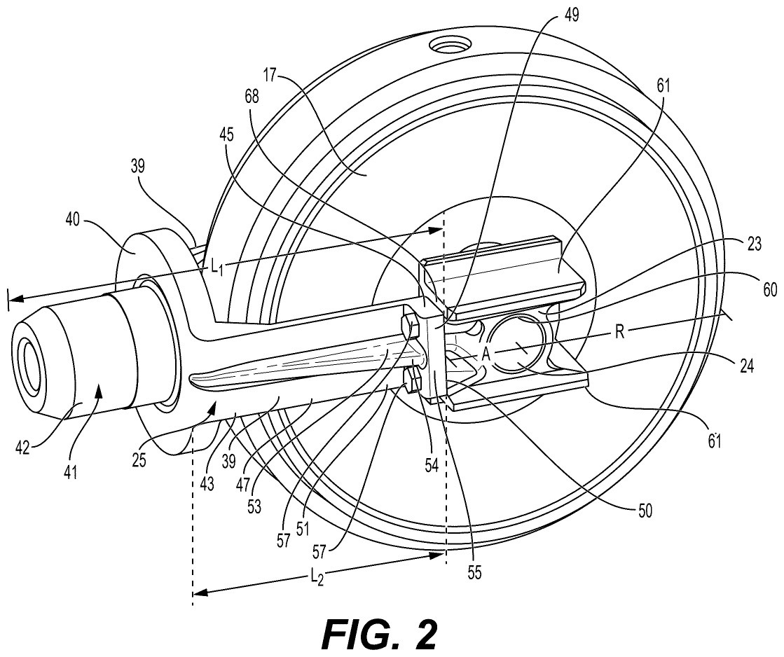

FIG. 2 depicts a portion of the idler assembly 20 of FIG. 1. In particular, FIG. 2 shows the yoke 25, one of the bearing blocks 23, and the idler wheel 17. The yoke 25 may include a pair of parallel legs 39 integrally connected to a spring receiving hub 41, and may have a total length L₁. The total length L₁ of the yoke 25 may be longer than a majority of the radius R of the idler wheel 17. The spring receiving hub 41 may have a circular base 40 and a cylindrical protrusion 42 extending proximally towards the adjustment cylinder 29 (FIG. 1). The legs 39 may have a proximal end 43 and a distal end 45. Each of the legs 39 may form an L-shape, including a longitudinal portion 47 extending between the proximal end 43 and the distal end 45, as well as a distal platform 49 at the distal end 45 extending outwardly from and normal to the longitudinal portion 47. An outer surface 51 of each leg 39 (e.g., a surface facing away from idler wheel 17) may include a proximally tapering rib 53. The proximally tapering rib 53 may be centrally located on the outer surface 51 of each of the legs 39 and may extend from the spring receiving hub 41 to the distal platform 49 of the leg 39 such that the a distal end 54 of rib 53 abuts the distal platform 49. The distal end 54 of the proximally tapering rib 53 may also be approximately coextensive with an outer surface 55 of the distal platform 49. The legs 39 may have a L₂. The length L₂ of the legs 39 may be longer than a majority of the radius R of the idler wheel 17 and may be longer than a distance A from the center of the idler wheel 17 to a planar proximal end 68 of the bearing blocks 23.

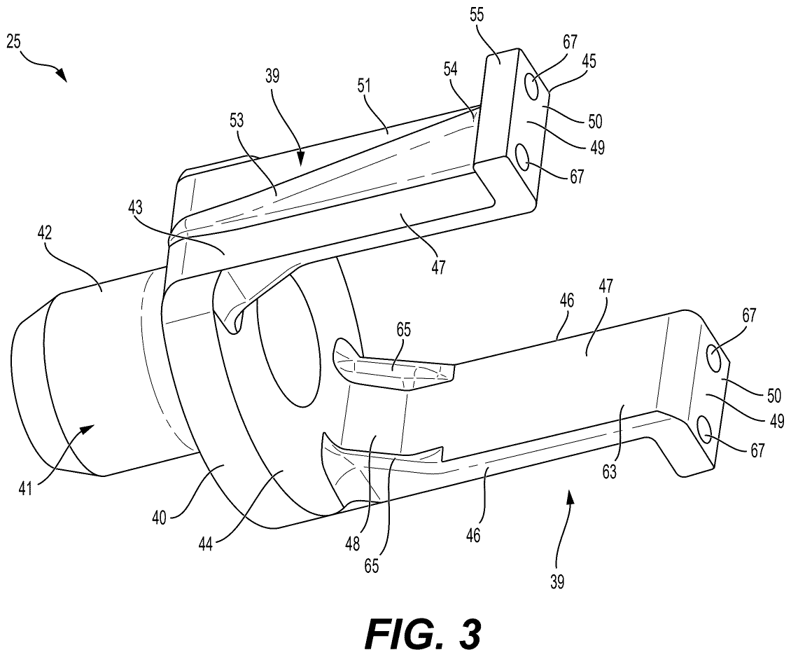

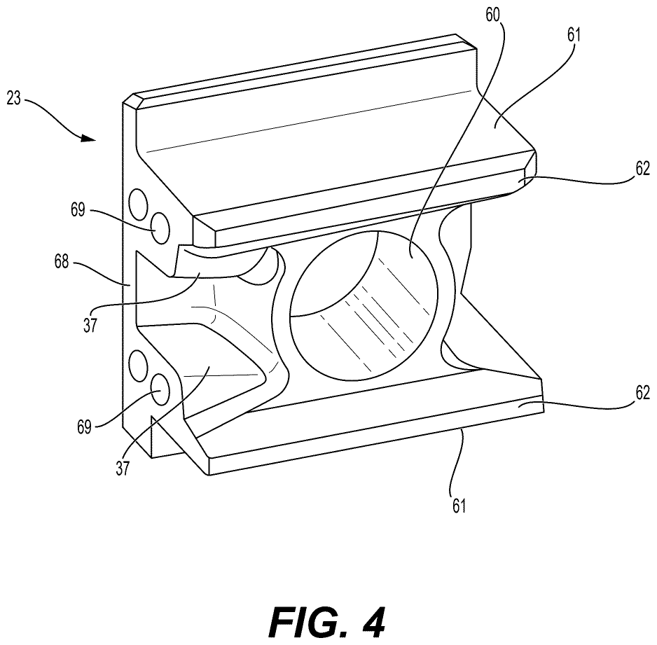

Still referring to FIG. 2, the bearing blocks 23 may be generally rectangular with a central hole 60 for rotatably receiving the axle 24. For example a sleeve bearing may be located in central hole 60 between the bearing block 23 and the rotating axle 24. The bearing blocks 23 may include a pair of rails 62 (FIG. 4) having outer contact surfaces 61 that slidably connect the bearing blocks 23 to the frame 13 (FIG. 1). The bearing blocks 23 may also include the planar proximal end surface 68 configured to abut a distal planar end surface 50 of the yoke legs 39. The planar proximal end surfaces 68 of the bearing blocks 23 and the distal planer surfaces 50 each have aligned holes 67, 69 (FIGS. 3 and 4) therethrough for receiving coupling bolts 57 that fixedly secure legs 39 to bearing block 23.

The yoke 25 and the bearing blocks 23 may be formed from different materials or by different processes. In some examples, the bearing blocks 23 may be made of a lighter, cheaper, or weaker material than the yoke 25. In some examples, the yoke 25 and the bearing blocks 23 may be made from different types of material, such as steel, or may be made from different processes, such as casting.

FIG. 3 is a detailed perspective view of the yoke 25 of FIGS. 1 and 2. As show in FIG. 3, the legs 39 of the yoke 25 may further include an inner surface 63 and a pair of inner ribs 65 at a junction between the proximal end 43 of legs 39 and a distal end surface 44 of the spring receiving hub 41. Each of the pair of inner ribs 65 may be located at and coextensive with a side 46 of leg 39 and be separated by a built-up and angled central leg junction 48. Further, each rib may taper distally as shown in FIG. 3. As discussed above, the distal platform 49 may further include a pair bolt holes 67 for receiving the coupling bolts 57 (FIGS. 1 and 2), with one of the bolt holes 67 on each side of the proximally tapering rib 53.

FIG. 4 is a detailed perspective view of a bearing block 23 of FIG. 1. As shown in FIG. 4, the bearing blocks 23 may include the pair of bolt holes 69 located in proximal end surface 68 so as to align or mate with the bolt holes 67 of the legs 39. Bolt holes 69 may generally align with the rails 62 of bearing block 23.

### Industrial Applicability

The disclosed aspects of the idler assembly may be used, for example, in any undercarriage system having an endless track. Such endless tracks can be found, for example, in mobile industrial machines such as dozers, excavators, and skid-steer loaders.

The tensioning system 21 within the idler assembly 20 may be used to vary tension in the track chain 19. By adding or removing grease from the adjustment cylinder 29, the adjustment cylinder 29 may expand or contract. The expansion or contraction the adjustment cylinder 29 moves the yoke 25 and the attached bearing blocks 23 left or right, accordingly. As the bearing blocks 23 move, the bearing blocks 23 slide along the upper and lower plates 31, 33 of the frame 13. As the bearing blocks 23 slide, the bearing blocks 23 push or pull the idler wheel 17, thereby varying the tension in the track chain 19.

The bearing blocks 23 may wear as they slide. This wear may be at a faster rate than other components within the idler assembly 20. The shape of the bearing blocks 23 of the present disclosure reduces the amount of effort or time needed to replace the bearing blocks 23 as the shape may reduce the weight or mass of the bearing blocks, making them easier to handle. The shape of the bearing blocks 23 may also reduce the cost of the bearing blocks 23, and allow for simpler, structurally weaker, or less expensive forms of manufacturing relative to other components, such as the yoke 25.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. An idler assembly, comprising:
a yoke including:
a pair of parallel legs, each leg including an inner surface, an outer surface, a proximal end and a distal end; and
a spring receiving hub integrally connecting the proximal ends of the pair of parallel legs.

2. The idler assembly of claim 1, wherein the outer surface of each leg includes a proximally tapering rib.

3. The idler assembly of claim 2, wherein the proximally tapering rib is centrally located on the outer surface of the leg.

4. The idler assembly of claim 2, wherein the proximally tapering rib extends from the hub to a distal platform of the leg.

5. The idler assembly of claim 2, wherein each leg forms an L-shape including a longitudinal portion and a distal platform extending outwardly from and normal the longitudinal portion.

6. The idler assembly of claim 5, wherein the distal platform includes a pair of bolt holes, with one bolt hole on each side of the proximally tapering rib.

7. The idler assembly of claim 5, wherein a distal end of the proximally tapering rib is coextensive with an outer surface of the distal platform.

8. The idler assembly of claim 5, wherein each leg includes at least one inner rib at a junction between a respective leg and the spring receiving hub.

9. The idler assembly of claim 1, wherein the idler assembly further includes a pair of bearing blocks, one of the bearing blocks connected to a distal end of each of the yoke legs, the bearing blocks having a pair of bolt holes facing a respective yoke leg.

10. The idler assembly of claim 9, wherein the yoke is formed of a different material than the bearing block.

11. The idler assembly of claim 1, wherein the yoke has a length longer than a radius of an idler wheel that idler assembly is configured to attach to.

12. An idler assembly for an excavator, the idler assembly comprising:
a pair of bearing blocks; and
a yoke including:
a pair of parallel legs, each leg including an inner surface, an outer surface, a proximal end and a distal end, and each leg being connected at the distal end to a respective bearing block; and
a spring receiving hub integrally connecting the pair of parallel legs at the proximal ends thereof.

13. The idler assembly of claim 12, wherein the bearing blocks include a planar proximal end surface configured to abut a distal planar end surface of the legs.

14. The idler assembly of claim 12, wherein each bearing block includes a pair of contact surfaces for slidably connecting the bearing blocks to a frame.

15. The idler assembly of claim 12, wherein each leg forms an L-shape including a longitudinal portion and a distal platform extending outwardly from and normal the longitudinal portion.

16. The idler assembly of claim 15, wherein a pair of bolts extends between each distal platform and a respective bearing block.

17. An idler assembly for tensioning a track of a mobile machine, comprising:
an idler yoke including:
a pair of parallel legs, each leg including an inner surface, an outer surface, a proximal end and a distal end, and each parallel leg further including a longitudinal portion and a distal platform extending outwardly from and normal the longitudinal portion and the outer surface of each leg includes a centrally located tapering rib; and
a spring receiving hub integrally connecting the pair of parallel legs at their proximal ends.

18. The idler assembly of claim 17, wherein the parallel legs extend along a majority of a radius of an idler wheel.

19. The idler assembly of claim 17, wherein the tapering rib abuts the distal platform.

20. The idler assembly of claim 17, wherein the distal end of each leg includes a pair of bolt holes for mating with bolt holes of a bearing block.
